(19) United States
(12) Patent Application Publication
(10) Pub. No.: US 2025/0013990 A1
(43) Pub. Date: Jan. 9, 2025

(54) Non-Fungible Token-Based Vehicle Maintenance Information Verification for a Plurality of Vehicles Using a Non-Fungible Token-Based System

(71) Applicants: Hyundai Motor Company, Seoul (KR); Kai Corporation, Seoul (KR); Sogang University Research & Business Development Foundation, Seoul (KR)

(72) Inventors: Jae Hyuk Choi, Seoul (KR); Sung Woo Cho, Gwangmyeong-Si (KR); Soo Yong Park, Seoul (KR); Jung Won Seo, Seoul (KR)

(21) Appl. No.: 18/521,249

(22) Filed: Nov. 28, 2023

(30) Foreign Application Priority Data
Jul. 3, 2023 (KR) 10-2023-0085829

(51) Int. Cl. G06Q 10/20; G06Q 20/10; G06Q 20/36; G06Q 20/38; G06Q 20/40

(52) U.S. Cl. CPC G06Q 10/20; G06Q 20/10; G06Q 20/3672; G06Q 20/3827; G06Q 20/389; G06Q 20/401

(57) ABSTRACT

A seller terminal for trading a NFT recording a management history of a used vehicle is provided. The seller terminal may include: a communication interface; an input/output unit; one or more processors; and a storage medium storing one or more programs configured to be executable by the one or more processors, wherein the one or more processors may be configured to receive a management history of a used vehicle through the input/output unit, transmit an issuance request for a non-fungible token (NFT), which records the management history of the used vehicle, to a blockchain network through the communication interface, transmitting the issuance request, meaning calling an issuance function 4 contract stored in the blockchain network, wherein the management history of the used vehicle may include at least one of accident history, maintenance history, mileage, and owner replacement history.

### CROSS-REFERENCE TO RELATED APPLICATION(S)

This application claims benefit of priority to Korean Patent Application No. 10-2023-0085829 filed on Jul. 3, 2023 in the Korean Intellectual Property Office, the disclosure of which is incorporated herein by reference in its entirety.

### BACKGROUND

As the size of the market for used vehicles has recently expanded, transparent maintenance information for used vehicles is very important.

Therefore, there is demand for securing transparency of a used vehicle history data (e.g., accident history, maintenance history, or the like).

### SUMMARY

The following summary presents a simplified summary of certain features. The summary is not an extensive overview and is not intended to identify key or critical elements.

A first terminal may comprise: a communication interface; a user interface; one or more processors; and a storage medium storing instructions that, when executed by the one or more processors, cause the first terminal to: receive, via the user interface, a maintenance history of a used vehicle, and transmit, to a blockchain network via the communication interface, an issuance request of a non-fungible token (NFT), recording the maintenance history of the used vehicle, wherein the issuance request is configured to cause an NFT-based contract device to perform an issuance operation of an NFT-based contract associated with the blockchain network, wherein the maintenance history of the used vehicle comprises at least one maintenance record of the used vehicle and further comprises at least one of: an accident history of the used vehicle, mileage information of the used vehicle, or an owner change history of the used vehicle.

The instructions, when executed by the one or more processors, may cause the first terminal to: receive an issued NFT associated with the maintenance history of the used vehicle; storing the issued NFT in an electronic wallet linked to the first terminal, wherein the issued NFT is associated with an issuance history of the issued NFT stored in the blockchain network, and wherein the issuance history of the issued NFT comprises: a token identifier (ID) of the issued NFT; a hash value associated with the maintenance history of the used vehicle; a verification field for the maintenance history of the used vehicle; and a value indicating a quantity of tokens corresponding to a transaction price of the issued NFT, wherein the hash value indicates an address of a storage where the maintenance history of the used vehicle is to be stored.

The instructions, when executed by the one or more processors, may cause the first terminal to store, based on the hash value, the maintenance history of the used vehicle in the storage.

The instructions, when executed by the one or more processors, may cause the first terminal to store the maintenance history of the used vehicle in the electronic wallet linked to the first terminal.

A verification result value of the verification field may be based on a comparison of a maintenance history of the used vehicle stored in at least one external terminal associated with the blockchain network and the maintenance history of the used vehicle stored in the electronic wallet linked to the first terminal.

The verification result value may be configured to be received from the at least one external terminal (e.g., a purchase terminal).

The instructions, when executed by the one or more processors, may cause the first terminal to perform a token transaction operation associated with the NFT-based contract, wherein the token transaction operation associated with the NFT-based contract is configured to cause: withdrawal of tokens, corresponding to the quantity of tokens, from an electronic wallet linked to a second terminal associated with a purchaser of the used vehicle; transfer of the withdrawn tokens to the electronic wallet linked to the first terminal; withdrawal of the issued NFT stored in the electronic wallet linked to the first terminal; and transfer of the withdrawn NFT to the electronic wallet linked to the second terminal.

The token transaction operation may be at least partially based on an Ethereum Request for Comments (ERC) 721 contract protocol, and wherein authorization for the withdrawal of the tokens is configured to be granted based at least partially on the ERC 721 contract protocol and an approval operation of an ERC 20 contract protocol.

The approval operation may be associated with an address of the ERC 721 contract protocol entered in a spender corresponding to a subject to withdraw at least one token.

The NFT may be an NFT to be issued according to an Ethereum Request for Comments (ERC) 721 contract protocol associated with the NFT-based contract, and the issuance operation is associated with a Mint function according to the ERC 721 contract protocol.

A second terminal may comprise: a communication interface; a user interface; one or more processors; and a storage medium storing instructions that, when executed by the one or more processors, cause the second terminal to: verify, based on communication via the communication interface and based on an non-fungible token (NFT)-based verification operation, a maintenance history of a used vehicle; display the maintenance history of the used vehicle; and transmit, to a blockchain network via the communication interface, a purchase request for an issued NFT in which the maintenance history of the used vehicle is recorded, wherein the purchase request is configured to cause an NET-based contract device to perform a token transaction operation of an NFT-based contract associated with the blockchain network, wherein the maintenance history of the used vehicle comprises at least one maintenance record of the used vehicle and further comprises at least one of: an accident history of the used vehicle, mileage information of the used vehicle, or an owner change history of the used vehicle.

The instructions, when executed by the one or more processors, may cause the second terminal to perform the token transaction operation by: withdrawing tokens, corresponding to a quantity of tokens, from an electronic wallet linked to the second terminal; transferring the withdrawn tokens to an electronic wallet linked to a first terminal associated with a seller of the used vehicle; withdrawing the issued NFT that is stored in the electronic wallet linked to the first terminal; and transferring the withdrawn NFT to the electronic wallet linked to the second terminal.

The token transaction operation may be at least partially based on an Ethereum Request for Comments (ERC) 721 contract protocol, and wherein authorization for the withdrawal of the tokens is configured to be granted based at least partially on the ERC 721 contract protocol and an approval operation of an ERC 20 contract protocol.

The approval operation may be associated with an address of the ERC 721 contract protocol entered in a spender corresponding to a subject to withdraw at least one token.

The instructions, when executed by the one or more processors, may cause the second terminal to: receive the issued NFT, wherein the received NFT is stored in an electronic wallet linked to a first terminal associated with a seller of the used vehicle, wherein the received NFT is associated with an issuance history of the issued NFT stored in the blockchain network, and wherein the issuance history of the issued NFT comprises: a token identifier (ID) of the issued NFT; a hash value associated with the maintenance history of the used vehicle; and a verification field for the maintenance history of the used vehicle; and a value indicating a quantity of tokens corresponding to a transaction price of the issued NFT, wherein the hash value indicates an address of a storage where the maintenance history of the used vehicle is to be stored.

The instructions, when executed by the one or more processors, may cause the second terminal to store, based on the hash value, the maintenance history of the used vehicle in a storage.

The instructions, when executed by the one or more processors, may cause the second terminal to store the maintenance history of the used vehicle in the electronic wallet linked to the second terminal.

A verification result value of the verification field may be based on a comparison of a maintenance history of the used vehicle stored in at least one external terminal associated with the blockchain network and the maintenance history of the used vehicle stored in an electronic wallet linked to the first terminal.

The issued NFT may be an NFT issued according to an Ethereum Request for Comments (ERC) 721 contract protocol associated with the NFT-based contract, and an issuance operation of the issued NFT is associated with a Mint function according to the ERC 721 contract protocol.

At least one computing device may comprise: a communication interface; one or more processors; and a storage medium storing instructions that, when executed by the one or more processors, cause the at least one computing device to: determine, based on communication via the communication interface and based on a hash value of non-fungible token (NFT) information stored in a blockchain network, a maintenance history of a used vehicle; verify the determined maintenance history of the used vehicle by comparing the determined maintenance history of the used vehicle with a maintenance history of the used vehicle stored in an electronic wallet linked to a terminal associated with a seller of the used vehicle; and after the verification of the determined maintenance history of the used vehicle, transmit, to the terminal via the communication interface, the determined maintenance history of the used vehicle.

According to an aspect of the present disclosure, provided is a computer-readable storage medium in which a program for executing the method on a computer is recorded.

These and other features and advantages are described in greater detail below.

### BRIEF DESCRIPTION OF DRAWINGS

The above and other aspects, features, and advantages of the present disclosure will be more clearly understood from the detailed following description, taken in conjunction with the accompanying lead-outs, in which:

FIG. 1 is a diagram illustrating an entire system including a seller terminal and a purchaser terminal for trading an NFT recording a management history of a used vehicle;

FIG. 2 illustrates an interface screen for receiving a management history of a used vehicle implemented in an input/output unit of a seller terminal;

FIG. 3 illustrates an interface screen for verifying a management history of a used vehicle in a service providing server;

FIG. 4 illustrates an interface screen for purchasing an NFT implemented in an input/output unit of a purchaser terminal;

FIG. 5 is a flowchart illustrating a method of trading an NFT in which a management history of a used vehicle is recorded; and

FIG. 6 is a block diagram of a computing device capable of fully or partially implementing a seller terminal and a purchaser terminal for trading an NFT recording a management history of a used vehicle.

### DETAILED DESCRIPTION

Hereinafter, various examples of the present disclosure will be described with reference to the drawings. The detailed descriptions that follow are provided to facilitate a comprehensive understanding of the methods, devices and/or systems described herein. However, this is merely an example and the present disclosure is not limited thereto.

In describing the examples of the present disclosure, if it is determined that the detailed description of the known technology related to the present disclosure may unnecessarily obscure the subject matter of the present disclosure, the detailed description thereof will be omitted. In addition, terms to be described later are terms defined in consideration of functions in the present disclosure, which may vary according to the intention or custom of a user or operator. Therefore, the definition should be made based on the contents throughout this specification. The terminology used in the detailed description is only for describing the examples of the present disclosure and should in no way be limiting. Unless expressly used otherwise, singular forms of expression include plural forms. In this description, expressions such as “comprising” or “comprising” are intended to indicate any characteristic, number, step, operation, element, portion or combination thereof, one or more other than those described, and it should not be construed to exclude the existence or possibility of any other feature, number, step, operation, element, part or a combination thereof.

Hereinafter, various examples of the present disclosure will be described with reference to the drawings.

The detailed descriptions that follow are provided to facilitate a comprehensive understanding of the methods, devices and/or systems described herein. However, this is merely an example and the present disclosure is not limited thereto.

In describing the examples of the present disclosure, if it is determined that the detailed description of the known technology related to the present disclosure may unnecessarily obscure the subject matter of the present disclosure, the detailed description thereof will be omitted. In addition, terms to be described later are terms defined in consideration of functions in the present disclosure, which may vary according to the intention or custom of a user or operator. Therefore, the definition should be made based on the contents throughout this specification. The terminology used in the detailed description is only for describing the examples of the present disclosure and should in no way be limiting. Unless expressly used otherwise, singular forms of expression include plural forms. In this description, expressions such as “comprising” or “comprising” are intended to indicate any characteristic, number, step, operation, element, part or a combination thereof.

In the present disclosure, a non-fungible token (hereinafter, referred to as an ‘NFT’) is a cryptocurrency that cannot be replaced with other tokens, and a management history of a used vehicle may be recorded in an NFT. In addition, the NFT may be issued according to an ERC 721 contract included in a smart contract, but it should be noted that it is not necessarily limited thereto. Here, an Ethereum Request for Comment 721 (ERC 721) means a standard specification of the NFT.

In addition, in the present disclosure, a token refers to a cryptocurrency that can be replaced with another token. The above-described token means that it is issued according to an Ethereum Request for Comment 20 (ERC 20) included in the smart contract 111, but the present disclosure is not necessarily limited thereto. The above-described ERC 20 is a standard specification of a token set in an Ethereum blockchain network.

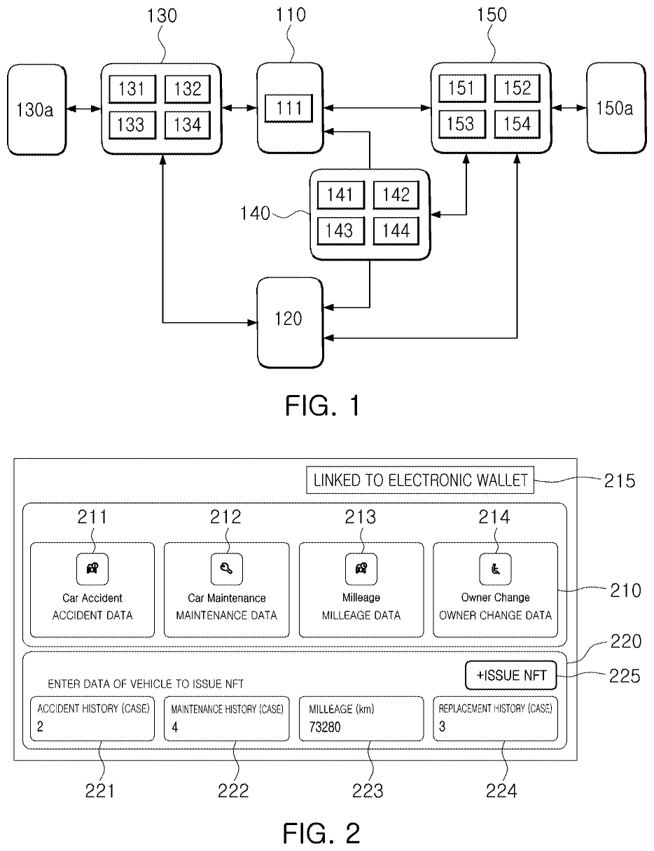

FIG. 1 is a diagram illustrating an entire system including a seller terminal and a purchaser terminal for trading an NFT recording a management history of a used vehicle. An entire system 100 may include a blockchain network 110, a storage 120, a seller terminal 130, an electronic wallet 130a linked to the seller terminal 130, a service providing server 140, a purchaser terminal 150, and an electronic wallet 150a linked to the purchaser terminal 150. The seller terminal 130, the service providing server 140, and the purchaser terminal 150, to be described later, may also participate as one of a plurality of nodes of the blockchain network 110.

First of all, a blockchain network 110 is a distributed network consisting of a plurality of nodes, and nodes constituting the blockchain network 110 may be terminals with computing capabilities, such as a computer, a dedicated electronic device, or the like. The seller terminal 130, the service providing server 140, and the purchaser terminal 150, to be described later, may also participate as one of a plurality of nodes of the blockchain network 110.

Such a blockchain network 110 may store and refer to information commonly known to all participating nodes within a connected bundle of blocks called a blockchain. This blockchain is a technology to prevent hacking such as forgery and falsification of transaction contents, and may send transaction history to users all participating in transactions, and may prevent data forgery by comparing the same for each transaction.

A smart contract 111 may be stored in the above-described blockchain network 110.

A smart contract is a kind of program, which is distributed and stored in a blockchain network, and is a script implementing an existing written contract as a code and executing the contract when specific conditions are satisfied. The smart contract may include an ERC 20 contract and an ERC 721 contract, and each contract may include various functions.

For example, the smart contract 111 may include an issuance function, and the above-described issuing function may be a function for issuing an NFT.

Specifically, the issuance function may issue an NFT to the seller terminal 130, and store the issued NFT in the electronic wallet 130a linked to the seller terminal 130. Here, the issuance history of the NFT may include NFT information including a token identification (ID) of the NFT, and a hash value and a verification field for the management history of the used vehicle, and the number of tokens, which is a sales price of the NFT, wherein the hash value may mean an address of the storage 120 where the management history of the used vehicle is to be stored.

Meanwhile, the above-described issuance function may store the management history of the used vehicle in the storage 120 based on the hash value.

The issuance function described above in the present disclosure may be a Mint function, which is a standard function, pre-implemented in the ERC 721 contract.

For example, the smart contract 111 may further include a purchase function.

The above-described purchase function may withdraw a predetermined number of tokens from an electronic wallet 150a linked to the seller terminal 150 and transmit the same to an electronic wallet 130a linked to the seller terminal 130, and withdraw an NFT stored in the electronic wallet 130a linked to the seller terminal 130 and transmit the same to the electronic wallet 150a linked to the purchaser terminal 150.

This purchase function is a newly implemented Purchase function in the ERC 721 contract, and may manage a token and an NFT through the Purchase function.

A code for implementing the Purchase function is shown as an example below.

```
  Function Purchase (address from, address to, uint256
td) public {
  _currencyAddr.transferFrom (msg.sender, address(this),
10);
  _transferFrom (from, to, td)
  }
```

As described above, after defining a variable from and a variable to of the Purchase function as an address, and a variable Td as a token ID of the NFT, and by entering an address of an ERC 721 contract in a variable from of _transferFrom, an address of the electronic wallet 150a linked to the purchaser terminal 150 in a variable to, and a token ID of the NFT, to be transferred, in a variable td, the ERC 721 contract may deliver an NFT having a token ID (td) to the electronic wallet 150a of the purchaser terminal 150.

Similarly, by entering an address of the electronic wallet 150a linked to the purchaser terminal 150 in a variable msg.sender of _currencyAddr.transferFrom and an address of an ERC 721 contract in a variable address (this), the ERC 721 contract may withdraw a predetermined number of tokens 10 from the electronic wallet 150a linked to the purchaser terminal 150.

In order to help the understanding the present disclosure, a code of the above-described Purchase function may be an exemplary code written assuming that a seller node 130 participates as one of a plurality of nodes of the blockchain network 110 and has a smart contract 111. Therefore, when the seller terminal 130 does not have a smart contract 111, a function for the ERC 721 contract to withdraw an NET having a token ID (td) from the electronic wallet 130a of the seller terminal 130 and a function for transferring a token withdrawn from the electronic wallet 150a linked to the purchaser terminal 150 to the electronic wallet 130a of the seller terminal 130 may be further included.

In order for the above-described ERC 721 contract for withdrawing a token from the electronic wallet 150a linked to the purchaser terminal, withdrawal authorization for the token is required.

In order for the above-described ERC 721 contract for withdrawing a token from the electronic wallet 150a linked to the purchaser terminal, withdrawal authorization for the token is required.

A code for implementing the approve function is shown as an example below.

```
  function approve (address spender, uint256 amount)
public virtual override returns (bool){
    address owner = msgSender( );
    _approve (owner, spender, amount)
    Return true:
  }
```

As described above, after defining a variable spender of the approval function (e.g., a function for approval, Approve function, approve function according to the ERC 20 contract, etc.) as an address, and a variable amount as an amount of tokens that can be withdrawn, and in _approve, by entering an address of the electronic wallet 150a linked to the purchaser terminal 150, which is a token owner, in a variable owner, an address of the ERC 721 contract in a variable spender, and the number of tokens that can be withdrawn in a variable amount. Withdrawal authorization for the token is required to the ERC 721 contract, and the number of tokens that can be withdrawn from the address of the electronic wallet 150a of the purchaser terminal 150, which is the token owner, may be limited.

Meanwhile, the above-described management history of the used vehicle may be stored based on a hash value. Here, the hash value may be an address of the storage 120 where the management history of the used vehicle is to be stored.

That is, the issuance history of the NFT, that is, NFT information including a token ID of the NFT, and a hash value and a verification field for the management history of the used vehicle, and the number of tokens, which is a sales price of the NFT, are stored in the blockchain 110, and the management history of the used vehicle described above based on the hash value may be stored in the storage 120, so that a problem in that storage capacity of the blockchain network 110 is exhausted may be solved.

The above-described storage 120 may be, for example, an Inter Planetary File System (IPFS).

IPFS is a file system distributing and storing a management history of a used vehicle in a plurality of nodes, and may be a distributed P2P file system connecting all nodes. IPFS is a faster, more secure and open network, realized by peer-to-peer (P2P) communication of nodes without a centralized server. Unlike a HTTP Web in the past, which had fatal consequences when a connection to a large server was blocked, in IPFS, even when several nodes are disconnected, the system can be maintained stably.

In addition, high-capacity files may be transferred quickly and efficiently (BitSwap), and a storage may be efficiently (Merkle DAG, contents-addressed) since duplication of the files may be known. The names of files uploaded on IPFS are recorded forever, and the file to be preserved on IPFS may be preserved semi-permanently (pinning). In addition, a version of the file version may be managed (Git).

Meanwhile, the seller terminal 130 is a terminal possessed by an owner of a used vehicle, and may be a device for selling an NET in which a management history of a used vehicle is recorded.

The seller terminal 130 may include an input/output unit 131, a control unit 132, a storage unit 133, and a communication interface 134.

The above-described seller terminal 130 may include a processor (e.g., a computer, a microprocessor, a CPU, an ASIC, a logic circuit, or the like) and a non-transitory memory storing software instructions providing functions of the above-described control unit 132 when executed by the processor. Here, the processor and memory may be implemented as separate semiconductor circuits. Alternatively, the processor and memory may be implemented as a single integrated semiconductor circuit. The processor may be one or more.

Specifically, the input/output unit 131 may receive a management history of a used vehicle.

Here, the management history of the used vehicle may include at least one of accident history, maintenance history, mileage, and owner replacement history.

FIG. 2 illustrates an interface screen for receiving a management history of a used vehicle implemented in an input/output unit of a seller terminal.

The input/output unit 131 of the seller terminal 130 may receive a management history of a used vehicle through an interface screen as shown in FIG. 2.

The interface screen may include a management history item of a used vehicle 210, and the management history item of the used vehicle 210 may include at least one of an accident history button 211, a maintenance history button 212, a mileage button 213, and an owner replacement history button 214.

For example, the number of accidents may be entered on a screen 221 displayed when the accident history button 211 is clicked, the number of maintenance may be entered on a screen 222 displayed when the maintenance history button 212 is clicked, the mileage may be entered on a screen 223 displayed when the mileage button 213 is clicked, and the number of owner replacement may be entered on a screen 224 displayed when the owner replacement history button 214 is clicked.

In the above-described examples, for example, the accident history illustrate the number of accidents, the maintenance history illustrate a cumulative mileage of a used vehicle, and the owner replacement history illustrate the number of owner replacements of a car, but this is an example to aid understanding of the present disclosure, and the present disclosure is not limited thereto.

That is, in addition to the number of accidents, the accident history may further include more specific history such as a date of the accident, a place of the accident, a damaged part, and the like due to the accident, the maintenance history may further include specific history such as a maintenance date, a maintenance site, or the like, in addition to the number of maintenance, and the owner replacement history of the vehicle may further include information on a previous owner, in addition to the number of owner replacement.

In addition, a button linked to an electronic wallet 215 among interface screens may be a button for linking the seller terminal 130 to the electronic wallet 110a.

A button for issuing an NFT 225 among interface screens may be a button for transmitting an issuance request of the NFT to the blockchain network 110.

The interface screen shown in FIG. 2 described above is to aid understanding of the present disclosure, and it is obvious to those skilled in the art that modifications may be implemented.

The control unit 132 may receive a management history of a used vehicle through the above-described input/output unit 131, and the input management history of the used vehicle may be stored in the electronic wallet 130a linked to the seller terminal 130.

In addition, when a button for issuing an NFT 225 among interface screens is clicked, the control unit 132 may transmit an issuance request for an NFT recording a management history of a used vehicle to the blockchain network 110. Here, transmitting the issuance request may mean calling an issuance function of the smart contract 111 stored in the blockchain network 110. The issuance function is as described above.

The storage unit 133 may store various programs for implementing functions performed by the control unit 132 described above.

Meanwhile, the communication interface 134 may communicate with the blockchain network 110 and the storage 120 under the control of the control unit 132 to transmit and receive various types of data described above.

Meanwhile, the service providing server 140 may include an input/output unit 141, a control unit 142, a storage unit 143, and a communication interface 144.

The above-described service providing server 140 may include a processor (e.g., a computer, a microprocessor, a CPU, an ASIC, a logic circuit, or the like), and a non-transitory memory storing software instructions providing functions of the above-described service providing server 140 when executed by the processor. Here, the processor and memory may be implemented as a separate semiconductor circuit. Alternatively, the processor and memory may be implemented as a single integrated semiconductor circuit. There may be provided one or more processors.

Specifically, the control unit 142 may load a management history of a used vehicle stored in the storage 120 based on a hash value of the NFT information stored in the blockchain network 110, compare the management history of the loaded used vehicle with a management history of the used vehicle stored in the electronic wallet 130a linked to the seller terminal 130, and enter a verification result (e.g., verification completed in a verification field according to the comparison result. In the present disclosure, verification through the service providing server 140, which is a separate terminal, is exemplified, but verification may be performed in the purchaser terminal 150 instead of the service providing server 140.

In addition, the control unit 142 may provide the management history of the used vehicle, for which verification has been completed, to the seller terminal 150.

The input/output unit 141 may display an interface screen for verifying a management history of a used vehicle.

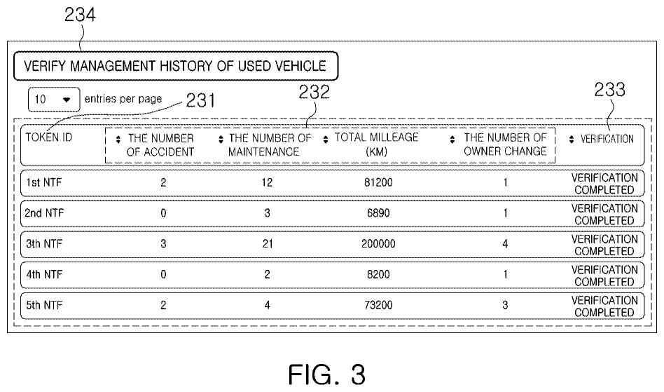

FIG. 3 illustrates an interface screen for verifying a management history of a used vehicle implemented in a service providing server.

As shown in FIG. 3, the interface screen may display a management history 232 of a corresponding used vehicle along with a token ID 231. The management history 232 of a used vehicle exemplarily illustrates the number times of accidents, the number of maintenance, the total mileage, and the number times of owner replacement. Thereafter, by clicking a button for verifying the management history 234, a verification result may be entered and displayed in the verification field 233.

The interface screen shown in FIG. 3 described above is to aid understanding of the present disclosure, and it is obvious to those skilled in the art that modifications may be implemented.

The storage unit 143 may store various programs for implementing functions performed by the control unit 142 described above.

Meanwhile, the communication interface 144 may communicate with the blockchain network 110, the storage 120, and the seller terminal 150 under the control of the control unit 142 to transmit and receive various data described above.

Meanwhile, the purchaser terminal 150 is a terminal possessed by a purchaser, and may be a device for purchasing a non-fungible token (NFT) recording a management history of a used vehicle.

The purchaser terminal 150 may include a control unit 151, an input/output unit 152, a storage unit 153, and a communication interface 154.

The above-described purchaser terminal 150 may include a processor (e.g., a computer, a microprocessor, a CPU, an ASIC, a logic circuit, and the like), and a non-transitory memory storing software instructions providing functions of the above-described control unit 151 when executed by the processor. Here, the processor and memory may be implemented as a separate semiconductor circuit. Alternatively, the processor and memory may be implemented as a single integrated semiconductor circuit. There may be provided one or more processors.

The control unit 151 may receive a list of purchasable NFTs including the management history of the used vehicle, for which verification has been completed, from the service providing server 140 and display the same through the input/output unit 152. The list of purchasable NFTs including the management history of the verified used vehicle may be directly loaded from the blockchain 110.

In addition, the control unit 151 may transmit a purchase request for an NFT in which a management history of a used vehicle is recorded to the blockchain network 110 through the communication interface 154. Here, transmitting the purchase request may mean calling a purchase function of the smart contract 111 stored in the blockchain network 110. The purchase function has already been described above.

Meanwhile, the input/output unit 152 may display a management history of a used vehicle, for which verification has been completed under the control of the control unit 151.

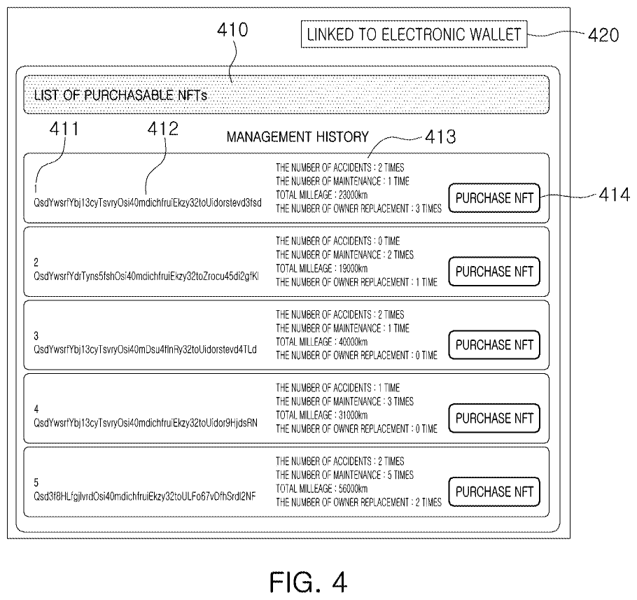

FIG. 4 illustrates an interface screen for purchasing an NFT implemented in an input/output unit of a purchaser terminal.

An input/output unit 152 of the purchaser terminal 150 may purchase an NFT through an interface screen as shown in FIG. 4.

The interface screen may include a list of purchasable NFTs 410, wherein the list of purchasable NFTs 410 may include a token ID 411, a hash value 412, a management history of the used vehicle, for which verification has been completed 413, and a NFT purchase button 414.

Thereafter, by clicking the NFT purchase button 414 provided in the management history 413 of the desired used vehicle, a purchase request for the NFT may be transmitted to the blockchain network 110.

Among the interface screens, an electronic wallet linkage button 420 may be a button for linking the purchaser terminal 150 and the electronic wallet 150a.

The storage unit 153 may store various programs for implementing functions performed by the control unit 151 described above.

Meanwhile, the communication interface 154 may communicate with the blockchain network 110 and the storage 120 under the control of the control unit 151 to transmit and receive various types of data described above.

As described above, by receiving a management history of a used vehicle including at least one of accident history, maintenance history, mileage, and owner replacement history, and issuing a non-fungible token (NFT) recording the same using the NFT for trading the used vehicle, it is possible to activate a market of the used vehicles and expand a size of the market of the used vehicles, by securing transparency of the management history of used vehicles.

Only an issuance history of NFTs may be stored in the blockchain network, and the management history of used vehicles may be stored in a separate storage based on the hash value, thereby solving a problem in which storage capacity of the existing blockchain network is exhausted.

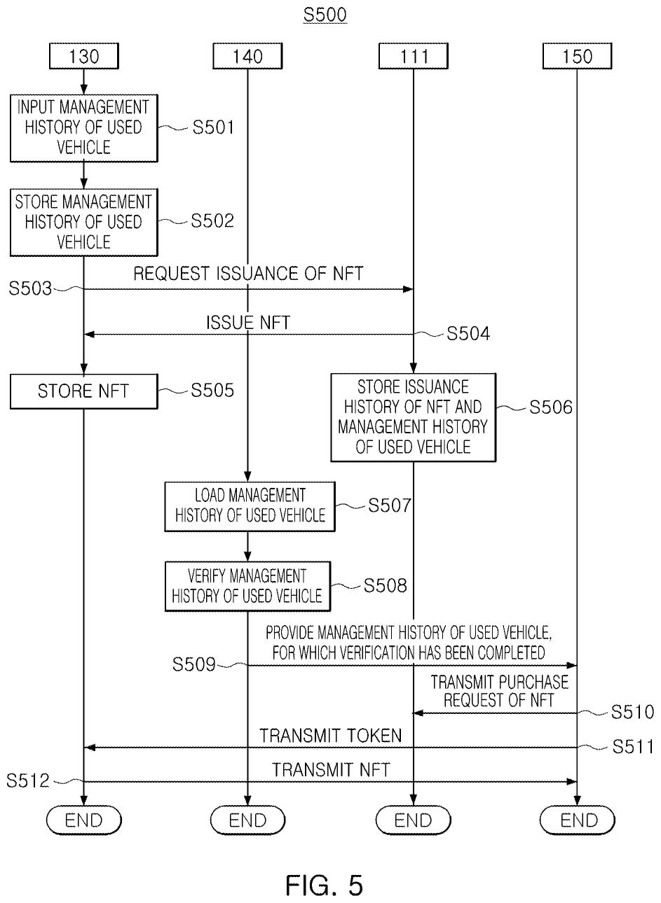

Meanwhile, FIG. 5 is a flowchart illustrating a method of trading an NFT in which a management history of a used vehicle is recorded.

Hereinafter, a method for trading an NFT (S500) recording a management history of a used vehicle will be described with reference to FIGS. 1 to 5. However, overlapping descriptions with those of FIGS. 1 to 4 are omitted for simplicity of the invention.

Referring to FIGS. 1 to 5, a method for trading an NFT (S500) recording a management history of a used vehicle may be initiated by an operation of receiving a management history of a used vehicle from a seller terminal 130. Here, as described above, the management history of the used vehicle may include at least one of accident history, maintenance history, mileage, and owner replacement history.

Next, the seller terminal 130 may store the entered management history of the used vehicle in an electronic wallet 130a linked to the seller terminal 130 (S502).

Thereafter, the seller terminal 130 may transmit an issuance request for an NFT to a blockchain network 110. Here, transmitting the issuance request may mean calling an issuance function of a smart contract 111 stored in the blockchain network 110. The issuance function is as described above.

Thereafter, the smart contract 111 may issue an NFT to the seller terminal 130 (S503), and the issued NFT may be stored in an electronic wallet 130a linked to the seller terminal 130 (S505).

In addition, the smart contract 111 may store an issuance history of the NFT in the blockchain network 110, and store a management history of the used vehicle in the storage 120 based on the hash value (S506). Here, the issuance history of the NFT includes NFT information including a token ID of the NFT, and a hash value and a verification field for the management history of the used vehicle, and the number of tokens, which is a sales price of the NFT, and as described above, the hash value is an address of a storage where the management history of the used vehicle is to be stored.

Thereafter, the service providing server 140 may load the management history of the used vehicle stored in the storage 120 based on the hash value of the NFT information stored in the blockchain network 110 (S507).

Thereafter, the service providing server 140 may verify a loaded management history of the used vehicle (S508). Specifically, the service providing server 140 may compare the loaded management history of the used vehicle with a management history of the used vehicle stored in the electronic wallet 130a linked to the seller terminal 130, and enter a verification result (e.g., verification completed) in the verification field according to the comparison result. Although verification through the service providing server 140, which is a separate terminal, is exemplified, in the present disclosure, verification may also be performed in the purchaser terminal 150 instead of the service providing server 140 as described above.

Next, the service providing server 140 may provide the management history of the used vehicle, for which has verification has been completed, to the purchaser terminal 150 (S509).

Thereafter, the purchaser terminal 150 may transmit a purchase request for an NFT in which the management history of the used vehicle is recorded to the blockchain network 110 (S510). Here, transmitting the purchase request means calling a purchase function of the smart contract 111 stored in the blockchain network 110 as described above.

Thereafter, the smart contract 111 may withdraw a predetermined number of tokens from an electronic wallet 150a linked to the purchaser terminal 150 and transmit the same to an electronic wallet 130a linked to the seller terminal 130 (S511), and withdraw an NFT stored in the electronic wallet 130a linked to the seller terminal 130 and transmit the same to the electronic wallet 150a linked to the purchaser terminal 150 (S512). The NFT withdrawn in the step S512 described above may be traded together with used vehicles.

An aspect of the present disclosure is to provide a seller terminal, a purchaser terminal, and a service providing server for trading an NFT recording a management history of a used vehicle, which can activate a market of the used vehicle and expand a size of the market of the used vehicle, by securing transparency of the management history of the used vehicle, and solve a problem in which storage capacity of the existing blockchain network is exhausted.

According to an aspect of the present disclosure, provided is a seller terminal for trading an NFT recording a management history of a used vehicle, the seller terminal including: a communication interface; an input/output unit; one or more processors; and a storage medium storing one or more programs configured to be executable by the one or more processors, wherein the one or more processors are configured to receive a management history of a used vehicle through the input/output unit, and transmit an issuance request of a non-fungible token (NFT), recording the management history of the used vehicle, to a blockchain network through the communication interface, transmitting the issuance request, meaning calling an issuance function of a smart contract stored in the blockchain network, wherein the management history of the used vehicle includes at least one of accident history, maintenance history, mileage, and owner replacement history.

According to an aspect of the present disclosure, provided is a purchaser terminal for trading an NFT recording a management history of a used vehicle, the purchaser terminal including: a communication interface; an input/output unit; one or more processors; and a storage medium storing one or more programs configured to be executable by the one or more processors, wherein the one or more processors are configured to display a management history of a used vehicle, for which verification has been completed through the input/output unit, and transmit a purchase request for the NFT in which the management history of the used vehicle is recorded to a blockchain network through the communication interface, transmitting the purchase request, meaning calling a purchase function of a smart contract stored in the blockchain network, wherein the management history of the used vehicle includes at least one of accident history, maintenance history, mileage, and owner replacement history.

According to an aspect of the present disclosure, provided is a service providing server for trading an NFT recording a management history of a used vehicle, the service providing server including: a communication interface; one or more processors; and a storage medium storing one or more programs configured to be executable by the one or more processors, wherein the one or more processors are configured to load a management history of a used vehicle based on a hash value of NET information stored in a blockchain network through the communication interface, verify the management history of the used vehicle by comparing the loaded management history of the used vehicle with a management history of a used vehicle stored in an electronic wallet linked to a seller terminal, and provide the management history of the used vehicle, for which verification has been completed through the communication interface to the seller terminal.

As described above, by receiving a management history of a used vehicle including at least one of accident history, maintenance history, mileage, and owner replacement history, and issuing a non-fungible token recording the same and using the NET for trading the used vehicle, transparency of the management history of the used vehicle may be secured to activate a market of the used vehicle and expand a size of the market of the used vehicle.

Only an issuance history of NFTs may be stored in the blockchain network, and the management history of the used vehicle may be stored in a separate storage based on the hash value, so that a problem in that storage capacity of the existing blockchain network is exhausted may be solved.

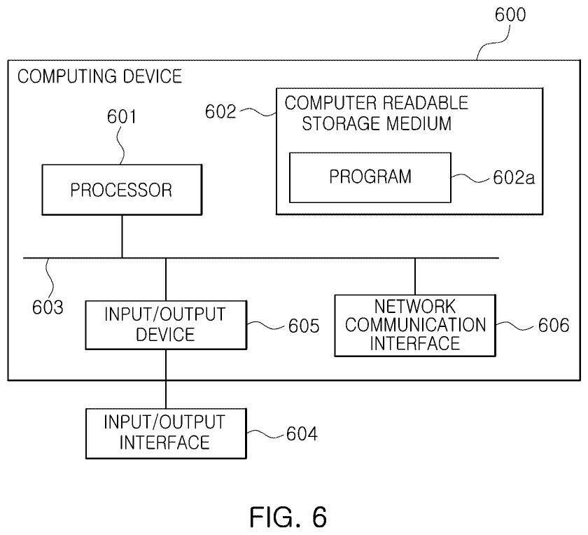

FIG. 6 is a block diagram of a computing device 600 capable of fully or partially implementing a seller terminal and a purchaser terminal for trading an NET recording a management history of a used vehicle.

As shown in FIG. 6, a computing device 600 includes at least one processor 601, a computer readable storage medium 602, and a communication bus 603.

The processor 601 may cause the computing device 600 to operate according to the above-described examples. For example, the processor 601 may execute one or more programs store in the computer-readable storage medium 602. The one or more programs may include one or more computer executable instructions, wherein, when executed by the processor 601, the computer-readable executable instructions may be configured to cause the computing device 600 to perform operations according to one or more configurations described herein.

The computer-readable storage medium 602 is configured to store computer-executable instructions or program code, program data, and/or other suitable forms of information. A program 602a stored on the computer-readable storage medium 602 includes a set of instructions executable by the processor 601. The computer-readable storage medium 602 may include a memory (a volatile memory such as a random access memory, a non-volatile memory, or a suitable combination thereof), one or more magnetic disk storage devices, optical disk storage devices, flash memory devices, other forms of storage media that can be accessed by the computing device 600 and store desired information, or suitable combinations thereof.

The communication bus 603 interconnects various other components of the computing device 600, including the processor 601 and the computer-readable storage medium 602.

The computing device 600 may also include one or more input/output interfaces 605 and one or more network communication interfaces 606 providing an interface for one or more input/output devices 604. The input/output interface 605 and the network communication interface 606 are connected to the communication bus 603. The network may be either a cellular network, such as a global system for mobile communications (GSM), enhanced data rates for GSM evolution (EDGE), a general packet radio service (GPRS), a code division multiple access (CDMA), a time division CDMA (TD-CDMA), a universal mobile telecommunications system (UMTS), a long term evolution (LTE), or another cellular network.

The input/output device 604 may be connected to other components of the computing device 600 through the input/output interface 605. The exemplary input/output device 604 may include an input device such as a pointing device (a mouse, a trackpad, or the like), a keyboard, a touch input device (a touchpad, a touchscreen, or the like), a voice or sound input device, various types of sensor devices, and/or a photographing device, and an output device such as a display device, a printer, a speaker, and/or a network card. The exemplary input/output device 604 may be included inside the computing device 600 as a component constituting the computing device 600, or may be connected to the computing device 600 as a separate device, distinct from the computing device 600.

Meanwhile, one or more aspects of the present disclosure may include a program for performing the methods described in this specification on a computer, and a computer readable recording medium including the program. The computer-readable recording medium may include program instructions, local data files, local data structures, or the like, alone or in a combination thereof. The medium may be specially designed and configured for the present disclosure, or may be commonly available in the field of computer software. Examples of the computer-readable medium may include a hardware device specially configured to store a magnetic medium such as hard disks, floppy disks and magnetic tapes, an optical recording medium such as CD-ROMS and DVDs, and program instructions such as ROM, RAM, and a flash memory and perform the same. Examples of the program may include not only machine language codes generated by a compiler, but also high-level language codes that may be executed by a computer using an interpreter.

As set forth above, by receiving a management history of a used vehicle including at least one of accident history, maintenance history, mileage, and owner replacement history, and issuing a non-fungible token (NFT) recording the history and using the same for trading the used vehicle, transparency of the management history of the used vehicle may be secured to activate a market of the used vehicle and expand a size of the market of the used vehicle.

Only an issuance history of NFTs may be stored in a blockchain network, and the management history of the used vehicle may be stored in a separate storage based on a hash value, so that a problem in which the storage capacity of the existing blockchain network is exhausted may be solved.

While the various examples have been illustrated and described above, it will be apparent to those skilled in the art that modifications and variations could be made without departing from the scope of the present invention as defined by the appended claims.

What is claimed is:

1. A first terminal comprising:
a communication interface;
a user interface;
one or more processors; and
a storage medium storing instructions that, when executed by the one or more processors, cause the first terminal to:
receive, via the user interface, a maintenance history of a used vehicle, and
transmit, to a blockchain network via the communication interface, an issuance request of a non-fungible token (NFT), recording the maintenance history of the used vehicle, wherein the issuance request is configured to cause an NFT-based contract device to perform an issuance operation of an NET-based contract associated with the blockchain network,
wherein the maintenance history of the used vehicle comprises at least one maintenance record of the used vehicle and further comprises at least one of: an accident history of the used vehicle, mileage information of the used vehicle, or an owner change history of the used vehicle.

2. The first terminal of claim 1, wherein the instructions, when executed by the one or more processors, cause the first terminal to:
receive an issued NFT associated with the maintenance history of the used vehicle;
storing the issued NFT in an electronic wallet linked to the first terminal,
wherein the issued NFT is associated with an issuance history of the issued NFT stored in the blockchain network, and
wherein the issuance history of the issued NFT comprises:
a token identifier (ID) of the issued NFT;
a hash value associated with the maintenance history of the used vehicle;
a verification field for the maintenance history of the used vehicle; and
a value indicating a quantity of tokens corresponding to a transaction price of the issued NFT,
wherein the hash value indicates an address of a storage where the maintenance history of the used vehicle is to be stored.

3. The first terminal of claim 2, wherein the instructions, when executed by the one or more processors, cause the first terminal to store, based on the hash value, the maintenance history of the used vehicle in the storage.

4. The first terminal of claim 2, wherein the instructions, when executed by the one or more processors, cause the first terminal to store the maintenance history of the used vehicle in the electronic wallet linked to the first terminal.

5. The first terminal of claim 4, wherein a verification result value of the verification field is based on a comparison of a maintenance history of the used vehicle stored in at least one external terminal associated with the blockchain network and the maintenance history of the used vehicle stored in the electronic wallet linked to the first terminal.

6. The first terminal of claim 5, wherein the verification result value is configured to be received from the at least one external terminal.

7. The first terminal of claim 2, wherein the instructions, when executed by the one or more processors, cause the first terminal to perform a token transaction operation associated with the NFT-based contract,
wherein the token transaction operation associated with the NET-based contract is configured to cause:
withdrawal of tokens, corresponding to the quantity of tokens, from an electronic wallet linked to a second terminal associated with a purchaser of the used vehicle;
transfer of the withdrawn tokens to the electronic wallet linked to the first terminal;
withdrawal of the issued NFT stored in the electronic wallet linked to the first terminal; and
transfer of the withdrawn NFT to the electronic wallet linked to the second terminal.

8. The first terminal of claim 7, wherein the token transaction operation is at least partially based on an Ethereum Request for Comments (ERC) 721 contract protocol, and
wherein authorization for the withdrawal of the tokens is configured to be granted based at least partially on the ERC 721 contract protocol and an approval operation of an ERC 20 contract protocol.

9. The first terminal of claim 8,
wherein the approval operation is associated with an address of the ERC 721 contract protocol entered in a spender corresponding to a subject to withdraw at least one token.

10. The first terminal of claim 1, wherein:
the NFT is an NFT to be issued according to an Ethereum Request for Comments (ERC) 721 contract protocol associated with the NFT-based contract, and
the issuance operation is associated with a Mint function according to the ERC 721 contract protocol.

11. A second terminal comprising:
a communication interface;
a user interface;
one or more processors; and
a storage medium storing instructions that, when executed by the one or more processors, cause the second terminal to:
verify, based on communication via the communication interface and based on an non-fungible token (NFT)-based verification operation, a maintenance history of a used vehicle;
display the maintenance history of the used vehicle; and
transmit, to a blockchain network via the communication interface, a purchase request for an issued NFT in which the maintenance history of the used vehicle is recorded, wherein the purchase request is configured to cause an NFT-based contract device to perform a token transaction operation of an NFT-based contract associated with the blockchain network,
wherein the maintenance history of the used vehicle comprises at least one maintenance record of the used vehicle and further comprises at least one of: an accident history of the used vehicle, mileage information of the used vehicle, or an owner change history of the used vehicle.

12. The second terminal of claim 11, wherein the instructions, when executed by the one or more processors, cause the second terminal to perform the token transaction operation by:
withdrawing tokens, corresponding to a quantity of tokens, from an electronic wallet linked to the second terminal;
transferring the withdrawn tokens to an electronic wallet linked to a first terminal associated with a seller of the used vehicle;
withdrawing the issued NFT that is stored in the electronic wallet linked to the first terminal; and
transferring the withdrawn NFT to the electronic wallet linked to the second terminal.

13. The second terminal of claim 12, wherein the token transaction operation is at least partially based on an Ethereum Request for Comments (ERC) 721 contract protocol, and
wherein authorization for the withdrawal of the tokens is configured to be granted based at least partially on the ERC 721 contract protocol and an approval operation of an ERC 20 contract protocol.

14. The second terminal of claim 13,
wherein the approval operation is associated with an address of the ERC 721 contract protocol entered in a spender corresponding to a subject to withdraw at least one token.

15. The second terminal of claim 11, wherein the instructions, when executed by the one or more processors, cause the second terminal to:
receive the issued NFT, wherein the received NET is stored in an electronic wallet linked to a first terminal associated with a seller of the used vehicle,
wherein the received NFT is associated with an issuance history of the issued NFT stored in the blockchain network, and
wherein the issuance history of the issued NFT comprises:
a token identifier (ID) of the issued NFT;
a hash value associated with the maintenance history of the used vehicle; and
a verification field for the maintenance history of the used vehicle; and
a value indicating a quantity of tokens corresponding to a transaction price of the issued NFT,
wherein the hash value indicates an address of a storage where the maintenance history of the used vehicle is to be stored.

16. The second terminal of claim 15, wherein the instructions, when executed by the one or more processors, cause the second terminal to store, based on the hash value, the maintenance history of the used vehicle in a storage.

17. The second terminal of claim 15, wherein the instructions, when executed by the one or more processors, cause the second terminal to store the maintenance history of the used vehicle in the electronic wallet linked to the second terminal.

18. The second terminal of claim 17, wherein a verification result value of the verification field is based on a comparison of a maintenance history of the used vehicle stored in at least one external terminal associated with the blockchain network and the maintenance history of the used vehicle stored in an electronic wallet linked to the first terminal.

19. The second terminal of claim 15, wherein:
the issued NFT is an NFT issued according to an Ethereum Request for Comments (ERC) 721 contract protocol associated with the NFT-based contract, and
an issuance operation of the issued NFT is associated with a Mint function according to the ERC 721 contract protocol.

20. At least one computing device comprising:
a communication interface;
one or more processors; and
a storage medium storing instructions that, when executed by the one or more processors, cause the at least one computing device to:
determine, based on communication via the communication interface and based on a hash value of non-fungible token (NFT) information stored in a blockchain network, a maintenance history of a used vehicle;
verify the determined maintenance history of the used vehicle by comparing the determined maintenance history of the used vehicle with a maintenance history of the used vehicle stored in an electronic wallet linked to a terminal associated with a seller of the used vehicle; and
after the verification of the determined maintenance history of the used vehicle, transmit, to the terminal via the communication interface, the determined maintenance history of the used vehicle.
